(19) United States
(12) Patent Application Publication
(10) Pub. No.: US 2014/0023956 A1
(43) Pub. Date: Jan. 23, 2014

(54) SILICON-BASED PROTON EXCHANGE MEMBRANE (PEM) AND METHOD OF MAKING A SILICON-BASED PEM

(71) Applicant: Mona Shannon, (US)

(72) Inventors: Saeed Moghaddam, Gainesville, FL (US); Mark A. Shannon, Champaign, IL (US); Charles Jeffrey Brinker, Albuquerque, NM (US)

(21) Appl. No.: 13/289,595

(22) Filed: Nov. 4, 2011

Related U.S. Application Data
(60) Provisional application No. 61/410,600, filed on Nov. 5, 2010.

(51) Int. Cl. H01M 8/10

(52) U.S. Cl. CPC H01M 8/1016
USPC 429/491

(57) ABSTRACT

A silicon-based proton exchange membrane for a membrane electrode assembly comprises a silicon wafer including a back side, a front side, and a membrane region therebetween, where the membrane region includes a plurality of channels extending from openings in the front side of the silicon wafer through the membrane region to openings in the back side of the silicon wafer. Walls of the channels include active sites to which a molecular species may be attached. Each of the front side and the back side of the silicon wafer includes a porous capping layer thereon. The capping layer comprises a plurality of through-thickness apertures contiguous with at least a portion of the channels of the membrane region.

### RELATED APPLICATION

The present patent document claims the benefit of the filing date under 35 U.S.C. 119(e) of U.S. Provisional Patent Application Ser. No. 61/410,600, filed on Nov. 5, 2010, which is hereby incorporated by reference in its entirety.

### FEDERALLY SPONSORED RESEARCH OR DEVELOPMENT

This subject matter of this application has been funded by the Defense Advanced Research Projects Agency (DARPA) under contract number DST 2007-0299513-000-1 and banner/UFAS no. 1-493673-687001-191100. The U.S. Government has certain rights in this invention.

### TECHNICAL FIELD

This disclosure is related generally to proton exchange membranes (PEMs) and more particularly to silicon-based PEMs.

### BACKGROUND

The ever increasing demand for powering portable devices has generated a worldwide effort for development of high energy density power sources. Although advancements in lithium-ion battery technology in recent years have provided higher power devices, this progress has not kept pace with the portable technologies, leaving a so-called power gap that is widely expected to grow in coming years.

Micro fuel cell (MFC) technology, which has been under development for some time, has the potential to bridge this power gap. The energy density of the fuels used in MFCs exceeds that of the batteries by an order of magnitude. However, efforts to harvest this high energy density have been hampered by issues concerning MFCs fabrication, performance, reliability, size, and cost. Proton exchange membrane (PEM) fuel cells could have applications in energy conversion and energy storage but their development has been impeded by problems with the membrane electrode assembly (MEA). At the heart of the issues is the use of polymer membranes (e.g., Nafion), which exhibit both low conductivity at low humidity and a large volumetric size change with humidity that is a major source of failure and integration difficulties.

Improved membrane materials and configurations have been widely sought for decades and would represent a key advancement in low-temperature fuel cell technology. In addition, development of a membrane compatible with the manufacturing infrastructure within the semiconductor and micro-electro-mechanical systems (MEMS) based silicon-processing industries could prove to be a major technological breakthrough.

### BRIEF SUMMARY

A surface nano-engineered fixed-geometry proton exchange membrane that can enable nearly constant proton conductivity over a wide humidity range with no changes in volume is introduced in the present disclosure. Additionally, the fabrication of such a membrane based on silicon is described. The technology may greatly facilitate manufacturing of membrane electrode assemblies (MEAS) and their further integration with microfabricated elements of MFCs.

A silicon-based proton exchange membrane for a membrane electrode assembly comprises a silicon wafer including a back side, a front side, and a membrane region therebetween, where the membrane region includes a plurality of channels extending from openings in the front side of the silicon wafer through the membrane region to openings in the back side of the silicon wafer. The channels include active sites on walls thereof to which a molecular species may be attached. A porous capping layer is disposed on each of the front side and the back side of the silicon wafer. The capping layer comprises a plurality of through-thickness apertures contiguous with at least a portion of the channels of the membrane region.

A method making a silicon-based proton exchange membrane for a membrane electrode assembly includes providing a silicon wafer comprising a thinned membrane region and having a back side and a front side, where the silicon wafer further comprises a first metal layer on the back side and a second metal layer on the first metal layer. The first and second metal layers extend over the membrane region. A plurality of channels are formed in the front side of the silicon wafer, and one or more of the channels extend through the membrane region to the back side of the silicon wafer to form one or more openings in the back side. One or more portions of the first metal layer exposed by the one or more openings in the backside are removed, thereby forming one or more exposed portions of the second metal layer, which are delaminated from the first metal layer. An entirety of the second metal layer is delaminated after substantially all of the channels extend through the membrane region to the back side, thereby forming a porous silicon membrane comprising a plurality of through-thickness pores.

### BRIEF DESCRIPTION OF THE DRAWINGS

FIG. 1 is a schematic of an exemplary porous silicon membrane with functionalized pore walls and thin porous capping layers on both sides of the membrane;

FIG. 2 shows a flow chart for fabrication of the exemplary porous silicon membrane of FIG. 1;

FIGS. 3(a)-3(f) include micrographs and data from fabrication of an exemplary porous silicon membrane; in particular, FIG. 3(a) shows a cross sectional view of the front side of a membrane fabricated in a two-cell anodization bath and FIG. 3(b) shows 1-2 microns from the backside of the membrane; FIG. 3(c) show variation of the anodization voltage at constant current showing a sudden rise in voltage when the electrolyte reaches the Cr layer; FIG. 3(d) is a schematic of the Au layer peel off process when the Cr layer is etched, and the insets show the actual images of two silicon dies—one with a single membrane and another with a 5×5 matrix of approximately 2×2 mm² membranes after completion of the process; the remaining Au layer outside the membrane area may later be used as a current collector in a complete MEA; FIGS. 3(e) and 3(f) show respective front side and back side cross sectional views of a membrane fabricated through the self-terminating process described in the present disclosure;

FIGS. 4(a)-4(c) provide FTIR spectra of a porous silicon membrane at different stages of pore surface modification anodized membrane left in DI water for a few hours; FIG. 4(b) shows an oxidized membrane at 300° C. in atmospheric O₂; FIG. 4(c) shows an oxidized membrane after room temperature DI water soak for 2 days (no further changes in spectra after 4 days was observed). Based on the drop in intensity of the 876 cm⁻¹ absorption peak during the DI soak process, the inventors assign this unsettled peak to the bending mode of —O₃SiH, since decrease in intensity of this mode is accompanied with that of the known peak 2260 cm⁻¹ and increase in 3743 cm⁻¹ intensity. Assignment of this peak to other modes such as Si—O stretching and the OH bending of the SiOH group coupling of Si—H and Si—O—Si motions seems inaccurate, since intensity of the Si—O, Si—O—Si, and SiOH bonds do not decline during the 2-day DI soak process. The inventors believe that the 1142 cm⁻¹ peak developed during the 2-day DI soak process may be due to surface oxide;

FIG. 5(a) shows a membrane functionalization reactor with a main chamber consisting of top and bottom compartments between which a silicon wafer is installed;

FIG. 5(b) shows time of flight-secondary ion mass spectro-scopy (ToF-SIMS) results (phased depth profile using a 22 kV Au+ analysis beam and a 2 kV Cs+ sputtering beam) showing composition of a functionalized membrane of 24 microns in thickness;

FIG. 6(a)-6(e) illustrates membrane pore size characterization and details of an exemplary MEA and its test package. FIGS. 6(a) and 6(b) show top views of two membranes without and with the PA-ALD silica layer, respectively; FIG. 6(c) shows water desorption isotherms of the membrane (determined using DVS-Advantage 1 machine manufactured by Surface Measurement Systems, Ltd. on samples with 25 membranes, shown in FIG. 3(d), at 25° C.); before functionalization (lower), after functionalization (middle), and after PD-ALD silica layer and subsequent functionalization (top); the graph also shows the corresponding Kelvin diameter as well as corrected Kelvin diameter based on Hagymassy et al. (J. Colloid Interface Sci. 29 (1969) 485-91) t-curve for silica surface, where using silica t-curve results in a small error in the case of the functionalized pores; FIG. 6(d) shows a cross-sectional schematic of a single membrane within its silicon die before and after application of catalyst layers; FIG. 6(e) shows a three-dimensional schematic of an MEA test package 600 showing two Teflon blocks 610a, 610b sandwiching the MEA 615 while two 50 μm thick gold foils 620 positioned in between come into contact with the anode and cathode electrodes to provide electrical connection to the outside of the package; hydrogen is supplied to the anode through a hole 625 within the bottom Teflon block 610b and an opening 630 in the top Teflon block 610a exposes cathode to air; the internal electrical resistance of the package 600 is measured to be 7 mΩ by replacing the device die with a gold foil and using the 4-probe measurement technique; and

FIGS. 7(a)-7(e) show plots illustrating the performance of a PS-PEM membrane and MEA using a dry hydrogen feed and an air-breathing cathode (tests were conducted at room temperature (−25° C.) with a hydrogen supply of 1.2-1.5 times the stoichiometric ratio and less than 1 kPa pressure); a single cell membrane was used in all tests; FIG. 7(a) shows proton conductivity as a function of humidity: PS-PEM with the PD-ALD-deposited silica layers, MEA-1 (open triangles), PS-PEM without the silica layers, MEA-2 (open squares), Nafion NRE-211 hot-pressed at 100° C., MEA-3 (open diamonds), N-117 heat-treated at 105° C. (solid triangles) and 30° C. testing temperature, N-117 at 30° C. (solid squares), N-117 at 30° C. (solid circles); FIG. 7(b) shows OCP as a function of humidity: MEA-1 (open triangles), MEA-2 (open squares), MEA-3 (open diamonds); FIG. 7(c) shows voltage-current and power characteristics of MEA-1 at moderate and low humidity ambient: 70%, 55%, and 25% and comparison with Pichonat and Gauthier-Manuel's PS-PEM; FIG. 7(d) shows the effect of high humidity on the MEA-1 performance: 95%, 92%, 85%, and 70%; FIG. 7(e) shows life test results at 150 mA/cm² operating current and 75% humidity; FIG. 7(f) shows membrane proton conductivity measured at different time periods after starting the test at 150 mA/cm² operating current and 75% humidity.

### DETAILED DESCRIPTION

A silicon-based inorganic-organic membrane that offers a number of advantages over Nafion—including higher proton conductivity, lack of volumetric size change, and membrane electrode assembly (MEA) construction capabilities—is described. Key to achieving these advantages is fabricating a silicon membrane with a high density of high aspect ratio nanoscale pores, adding a self-assembled molecular monolayer on the pore surface, and capping the pores with a layer of porous silica. The silica layer reduces the diameter of the pores and ensures their hydration, resulting in a proton conductivity of 2-3 orders of magnitude higher than that of Nafion at low humidity. A MEA constructed with this proton exchange membrane can deliver an order of magnitude higher power density than that achieved previously with a dry hydrogen feed and an air-breathing cathode.

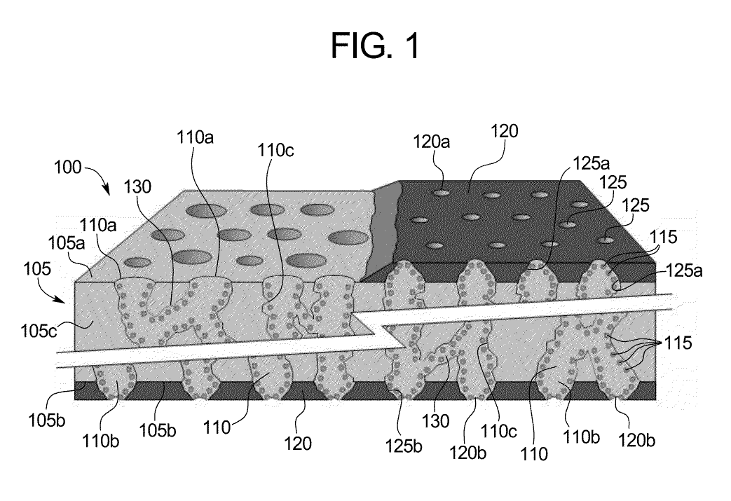

FIG. 1 provides a schematic of an exemplary silicon-based proton exchange membrane 100 for a membrane electrode assembly.

The membrane 100 is formed from a silicon wafer 105 having a front side 105a, a back side 105b, and a membrane region 105c therebetween. The membrane region 105c includes a plurality of proton-conducting channels (through-thickness pores) 110 that extend from openings 110a in the front side 105a of the silicon wafer 105 through the membrane region 105c to openings 110b in the back side 105b of the silicon wafer 105. The channels 110 may include active sites on the walls 110c for attachment to molecular species. It may be advantageous for at least about 10%, or preferably at least about 50%, of the active sites on the walls 110c to include a molecular species 115 attached thereto, in order to achieve a high surface coverage of molecules comprising a desired functional group. For example, the surface coverage may be as high as several molecules per square nanometer of channel wall area. Preferably, the molecular species 115 in each channel 110 form a self-assembled monolayer (SAM) over substantially all of the channel wall.

The channels 110, which may be interconnected 130, may be formed in a membrane 100 composed of crystalline or amorphous silicon. Molecular species that may be attached to the active sites include molecules having an appropriate functional group, such as a —SH end group. A suitable molecule is (3-mercaptopropyl)trimeth-oxysilane (MPTMS), SH—(CH₂)₃—Si—(OCH₃)₃. After functionalization, the —SH end group of the molecule may be oxidized to —SO₃H, which may exist as a sulfonate salt, depending on the pH. A suitable sulfonate is 3-(trimethoxysilyl)propane-1-sulfonate, Si(OCH₃)₃—(CH₂)₃—SO₃.

To enable maintenance of high conductivity at low humidity, an ultra-thin conformal layer of an insulating material may be deposited at the opening of each of the larger channels, creating small apertures. Referring again to FIG. 1, a thin porous capping layer 120 is disposed on the front side 105a and on the back side 105b of the silicon wafer 105 over the membrane region 105c. Each porous capping layer 120 includes a plurality of through-thickness apertures 125 contiguous with at least a portion of the channels 110 of the membrane region 105c. The apertures 125 may also include molecular species 115 attached to active sites on the aperture walls 125a, 125b. Using the Kelvin equation, ln RH=−2γV/rRT, one can calculate that a 1 nm diameter water meniscus can be stable at 10% humidity, which is lower than the humidity level in most practical applications of fuel cells. Although the specific conductivity of the capping layer can be relatively low, its overall contribution to total membrane resistance is negligible. In contrast to prior art membranes, this membrane construct maintains hydration without detrimentally decreasing proton conductivity.

The channels 110 extending through the membrane region 105c may have a diameter of between about 2 nm and about 10 nm. For example, the diameter may lie between about 4 nm and about 8 nm prior to adding the molecular species 115 that further reduce the diameter of the channels 110. (The term “diameter” is used broadly to refer to the average lateral size of the channels 110; the channels 110 are not required to have a circular lateral cross-section.) If the channel diameter is too large, then water may be lost by evaporation and the total channel density in the membrane may be undesirably decreased. At diameters that are too small, however, the proton conductivity may drop due to the reduced size of the passageways. Advantageously, the diameter of the channels is between about 5 nm and about 7 nm. Once functionalized, the diameter may be effectively reduced to between about 2 nm and about 5 nm.

The apertures 125 defined by the capping layers 120 that overlie the membrane region 105c may be tapered; specifically, they may have a diameter (average lateral size) that decreases with distance away from the membrane region 105c. Consequently, the porous capping layers 120 serve to shrink the size of the openings 110a, 110b to the channels 110. This may be advantageous to maintain hydration of the channels 110 without diminishing proton conductivity. In one example, the size of the aperture openings 120a, 120b may lie between about 1 nm and about 4 nm. The porous capping layers, which may be formed of silica or another hydrophilic and electrically insulating material, such as other oxides, nitrides (e.g., SiN), or oxynitrides, may have a thickness of between about 1 nm and about 5 nm each. In contrast, the silicon membrane region 105c has a much greater thickness that typically lies between about 10 microns and about 40 microns and may be between about 20 microns and about 30 microns.

Given the small diameter of the proton-conducting channels compared to the thickness of the membrane through which they pass, the channels have a large aspect ratio (length-to-width). The aspect ratio of the channels may range from about 1,000 to about 20,000 for example. The aspect ratio may also lie between about 5,000 and 15,000. Despite this high aspect ratio, the inventors are able to form a self-assembled monolayer over a large portion (or substantially all) of the channel walls by using a continuous flow method of attaching molecular species to the active sites, as described in detail below. Preferably, substantially all of the active sites on the walls of the channels include a functional group. In addition, molecular species may be attached to active sites on walls of the apertures of the porous capping layers.

It is possible, by way of the fabrication method described below, to produce a high density of relatively straight proton-conducting channels through the membrane. Proton conductivity may be enhanced at higher channel densities due to the increased number of pathways for protons to traverse. Channel or pore density can quantified in terms of the spacing between adjacent channels, where smaller spacings generally correlate with higher channel densities. It may be advantageous for the channels to have an average center-to-center spacing of about twice the diameter of the channels or less. For example, the average center-to-center spacing may be between about 4 nm and about 20 nm. The average center-to-center spacing may also lie between about 8 nm and about 16 nm, or between about 10 nm and about 14 nm.

In one example, the silicon-based membrane is fabricated to have about 5-7 nm diameter silicon channels with MPTMS (SH—(CH₂)₃—Si—(OCH₃)₃) molecules assembled on the modified surface of the channels. After functionalization, the —SH end group of MPTMS is oxidized to —SO₃H. The thickness of the resulting self-assembled monolayers (SAMs) of MPTMS on silicon oxide is 0.8±0.1 nm. An increase in the size of the head group after oxidation increases the SAMs thickness to around 1 nm. The overall size, then, of the channels after self-assembly reduces to between about 3 nm and about 5 nm.

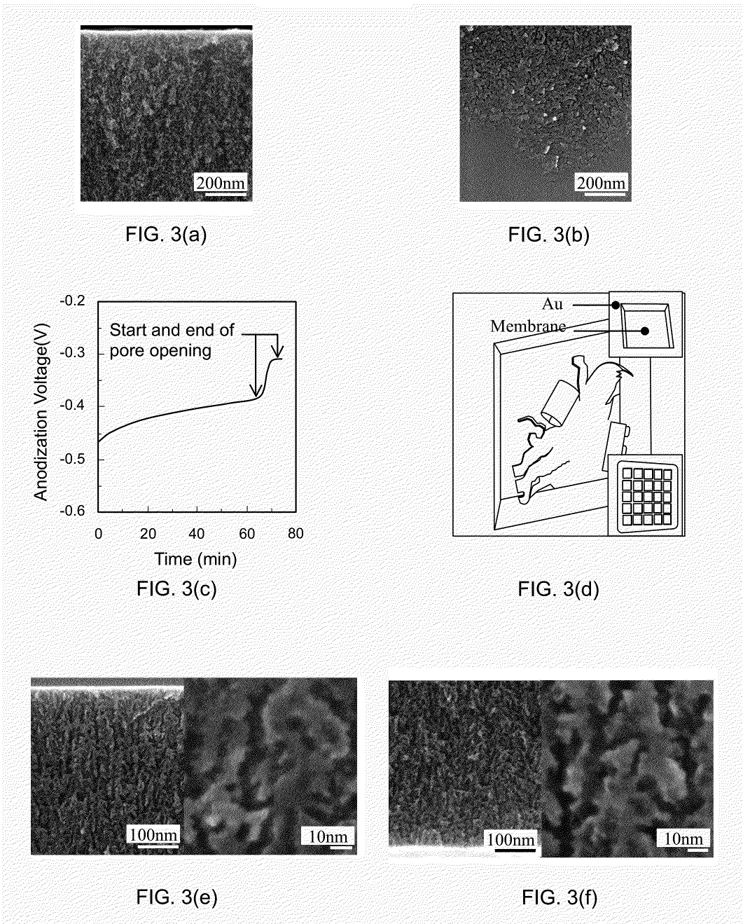

Anodization can be employed to create the channels in the silicon membrane. However, using a typical two-cell anodization process in which the wafer is installed between two electrolyte baths, the pores may not extend through the entire thickness of the membrane and a layer of nonporous silicon may remain on the backside. To open up the pores on the backside, the remaining silicon layer is generally etched using a plasma (e.g., Freon plasma). Due to variations in the thickness of the remaining silicon layer on a single membrane and over different membranes as well as the pore penetration depth (FIG. 3(b)), the silicon layer gets etched from some areas, exposing porous silicon, which is then etched at a much faster rate (3-5 times) than the nonporous silicon. This results in localized thinning of the membrane and makes fabrication of thin membranes impractical. In addition to the thickness issue, analysis of the composition of silicon membranes fabricated in this manner using time-of-flight secondary ion mass spectroscopy (ToF-SIMS) shows a significant rise in fluorine presence, particularly towards the backside of the membrane.

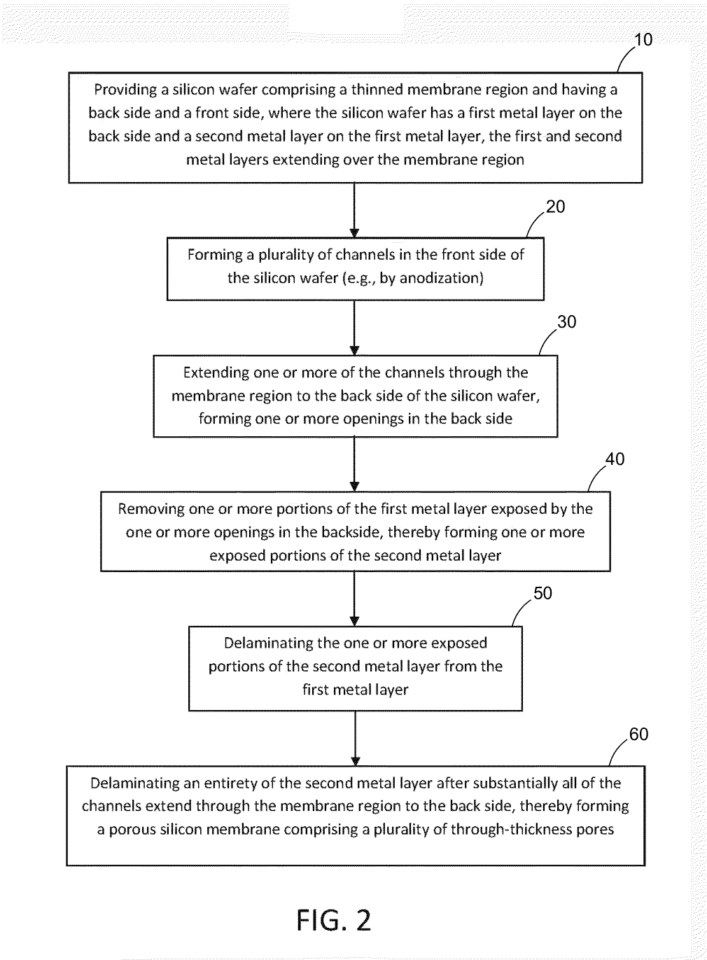

In order to overcome these issues, a new fabrication method has been developed that leads to production of membranes with uniform open-ended channels in a single step. The process is summarized here in reference to FIG. 2 and described in greater detail below. Once the porous membranes are formed, the high aspect ratio channels may be functionalized to include a self-assembled monolayer over the channel walls, and porous capping layers may be formed on the front side and back side of the membrane.

The method of forming the porous membrane entails depositing two metal layers (e.g., a first metal layer made of chromium (Cr) and a second metal layer made of gold (Au)) on the backside of a silicon wafer that includes a thinned membrane region. The first and second metal layers extend over the membrane region 10. A plurality of channels are formed in the front side of the silicon wafer 20 and extended through the membrane region to the back side of the wafer, forming a plurality of openings in the back side 30. The channels may be formed and grown through the membrane region by anodization, which entails immersing the silicon wafer and a cathode electrode in an electrolyte solution to form an anodization cell, and running an electrical current through the cell to initiate etching of the silicon to form the channels. Once one or more of the channels extends entirely through the thickness of the membrane region and creates one or more openings in the back side of the wafer, portions of the first metal layer exposed by the openings are removed (e.g., by etching) 40. This in turn exposes portions of the second metal layer, which are consequently detached or delaminated from the first metal layer 50. When this occurs, the self-terminating anodization process is halted locally (in the vicinity of the openings), although etching continues in other parts of the membrane region.

Delamination of the entire second metal layer occurs after substantially all of the channels extend through the membrane region to the back side 60 and much or all of the first metal layer is removed. After the process is complete, the first metal layer, which may be formed of gold or another noble metal, may be reused since it is not consumed in the process. The etching process proceeds at an extremely high rate, resulting in a porous silicon membrane comprising a plurality of channels or through-thickness pores that are densely packed across the membrane region.

The first metal layer is generally made of a transition metal with good adhesion to silicon, such as chromium, titanium and/or tungsten. A thickness of about 50 nm or less may be suitable. The second metal layer is typically made of a noble metal with good ductility, such as gold or platinum, and may be about 200 nm in thickness or less. Other metals that may be suitable for the second metal layer include palladium or nickel.

After the porous silicon membrane is fabricated, molecular species may be attached to active sites on walls of the through-thickness pores (i.e., the active sites may be functionalized) to form a self-assembled monolayer over substantially all of the channel walls. A continuous flow process that entails introducing a solute-rich solvent into channel openings on one side of the porous silicon membrane while extracting depleted solvent from channel openings on the other side of the porous silicon membrane may be used to carry out the functionalization. The solute-rich solvent may be, for example, a benzene solution comprising (3-mercaptopropyl)trimethoxysilane (MPTMS), and a solute concentration of between about 0.001 mM to about 100 mM. For example, a concentration of between about 1 mM and about 10 mM may be employed. To facilitate the functionalization, it may be advantageous to convert hydrophobic surface species at the active sites to hydrated silica prior to carrying out the continuous flow process. After attaching the molecular species to the active sites, oxidation of the molecular species may be employed to convert —SH end groups to —SO₃H.

Before or after functionalization, a porous capping layer may be deposited on the front side and also on the back side of the porous silicon membrane. The porous capping layers include a plurality of through-thickness apertures contiguous with at least a portion of the channels of the porous silicon membrane. Because the through-thickness apertures decrease in diameter (lateral size) in a direction away from the porous silicon membrane, they effectively reduce the size of the channel openings. As mentioned above, the silica layer ensures that the channels remain hydrated, resulting in a proton conductivity of 2-3 orders of magnitude higher than that of Nafion at low humidity. The porous capping layer is generally formed by atomic layer deposition (ALD), physical vapor deposition (e.g., sputtering or evaporation), or chemical vapor deposition (CVD) to have a thickness of about 10 nm or less. Preferably the thickness of the porous capping layer is about 5 nm or less. Molecular species may be attached to active sites on walls of the through-thickness apertures by either the continuous flow process described previously or by a dipping process.

### EXAMPLE 1

### Fabrication of Porous Silicon Membrane

Fabrication of the silicon membranes may begin with KOH etching of a p-doped <100> silicon wafer. A 0.8 μm thick LPCVD nitride layer is used as a protection mask in KOH solution. First, the nitride layer on the backside of the membrane is patterned and etched using a Freon plasma. The exposed silicon areas are then etched in KOH until a membrane thickness of 24±2 μm is reached. The nitride layer on the frontside of the membrane is subsequently patterned and etched to expose silicon. In membranes with an additional metal layer on the frontside, the patterning step is followed by wet etching of the metal layer and then Freon plasma etching of the nitride layer.

Prior to anodizing the silicon wafer, metal films may be deposited on the back side by using a magnetron sputtering system at 5×10⁻² Torr pressure and 300 W DC power in argon gas. The resulting backside Cr/Au layer may be wired directly to the anode electrode to provide an electrical path for the electrons to exit the silicon membrane once the pores penetrate to the backside of the membrane. When the pores open up at any location, the Cr layer gets etched at that location and the Au layer delaminates, resulting in a local electrical discontinuity and thereby anodization termination at that location. Since the Au layer does not get etched, it ensures electrical connectivity of the rest of the membrane to the circuit. The Au delamination process occurs gradually over the entire wafer until the pores on all membranes are opened. This event appears as a sudden rise in process voltage, as shown in FIG. 2c. The reason behind a finite increase in voltage is continuation of the anodization process beyond the edges of the membrane into the bulk silicon. Interestingly, the Au layer left outside the membrane can be used as the anode electrode. The cathode electrode is also a Cr/Au layer deposited on the frontside of the wafer prior to etching the nitride layer (both Cr/Au and nitride layers are etched in one patterning step).

### EXAMPLE 2

### Hydroxylation of Pore Walls

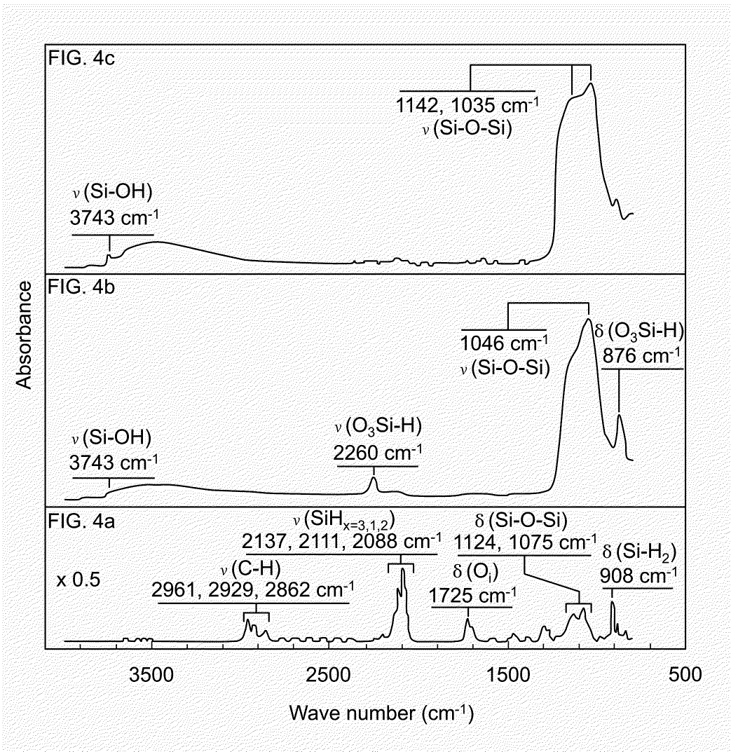

After the anodization process, the membrane may be left in de-ionized (DI) water for a few hours to clean the anodization electrolyte from the pores. As the Fourier Transfer Infrared (FTIR) spectra of the membrane (FIG. 4(a)) suggests, the pore wall is covered with SiHₓ (x=1-3) hydrophobic surface species (the absorption bands were assigned by Glass et al., Surf. Sci. 348 (1996) 325-334). To successfully conduct silane-based self-assembly within the membrane, the surfaces of the pores may be converted to hydrated silica. This can be achieved in two steps. First, the membrane may be partially oxidized at low temperature (300° C.) in an oxygen environment (e.g., O₂ furnace). Although close to 600° C. may be required to desorb surface hydride species, processing at such a temperature level is not practical due to significant changes in membrane morphology and membrane fracturing. The morphology of porous silicon is known to change at temperatures above 350-450° C. due to changes in crystalline dimensions (i.e., coarsening of the porous silicon texture). These changes may result in a significant decrease in the specific surface area. However, no distinct texture coarsening is observed at 300° C. The oxidized membrane spectrum shows that all Si—H₂ vibrational stretch modes have shifted to 2260 cm⁻¹ with a low intensity tail extending towards lower frequencies, suggesting that the backbone of the Si atoms are targeted by oxygen and the maximum degree of oxidation to —O₃SiH (corresponding to absorption at 2260 cm⁻¹ frequency) has occurred. The lower frequency tail also indicates the presence of a relatively small population of —O_{y}SiHₓ surface species. Leaving the membrane in DI water, after the oxidation step, results in insertion of oxygen into Si—H bonds and creation of SiOH surface species. As a result, the 2260 and 876 cm⁻¹ absorption bands associated with —O₃SiH stretching and bending modes, respectively, disappear and absorption at 3743 cm⁻¹, assigned to isolated SiOH species, intensifies along with the Si—O asymmetric stretching vibrations at 1200 to 1000 cm⁻¹ assigned to the siloxane network. The broad absorption band centered at around 3500 cm⁻¹ corresponds to the overlapping of the 0-H stretching bands of hydrogen-bonded water (H—O—H . . . H) and SiO—H stretching of surface silanols hydrogen-bonded to molecular water (SiO—H H₂O). These results suggest the creation of a well hydrated silica pore surface as desired for the subsequent self-assembly step.

### EXAMPLE 3

### Functionalization of Pore Walls

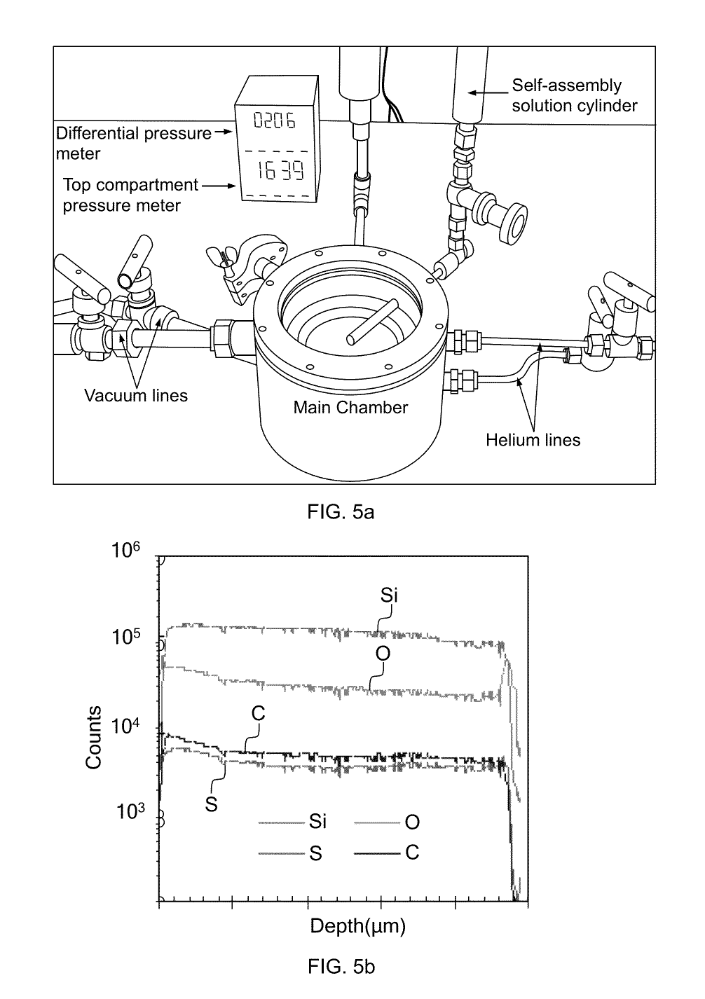

Due to the large surface area and high aspect ratio of the pores, a reactor was constructed (FIG. 5(a)) to continuously supply an approximately 1 mM solution of MPTMS to one end of the pores and extract the solvent from the opposite end.

The membrane die is installed within a fixture between the top and bottom compartments of the functionalization setup. This arrangement allows extraction of the depleted solvent from the bottom of the membrane pores continuously while the solute-rich solvent is supplied over the membrane. A typical process run involves evacuating the chamber and purging with helium multiple times to remove condensed water from the pores. Excess water results in self-polymerization of the MPTMS molecules and clogging of the pores (note that surface adsorbed water remains on the surface). Then, MPTMS in benzene solution is supplied to the solution reservoir on top of the membrane. While the top chamber was charged with helium and the vacuum and helium lines connected to it were closed, the lines connected to the bottom compartment were opened slightly to maintain a slow flow of dry helium. The process was continued until the top reservoir was emptied from solution.

This procedure enabled uniform functionalization of the hydroxyl groups within the membrane (estimated to be ˜5 sites/nm²) as confirmed by ToF-SIMS with depth profiling (shown in FIG. 4b). The —SH end group of the MPTMS molecule was then oxidized to —SO₃H in dilute nitric acid, and finally, the membrane was maintained in a large volume of DI water for 24 hrs to diffuse out the nitric acid and hydrate the pores.

### EXAMPLE 4

### Formation of Porous Capping Layers

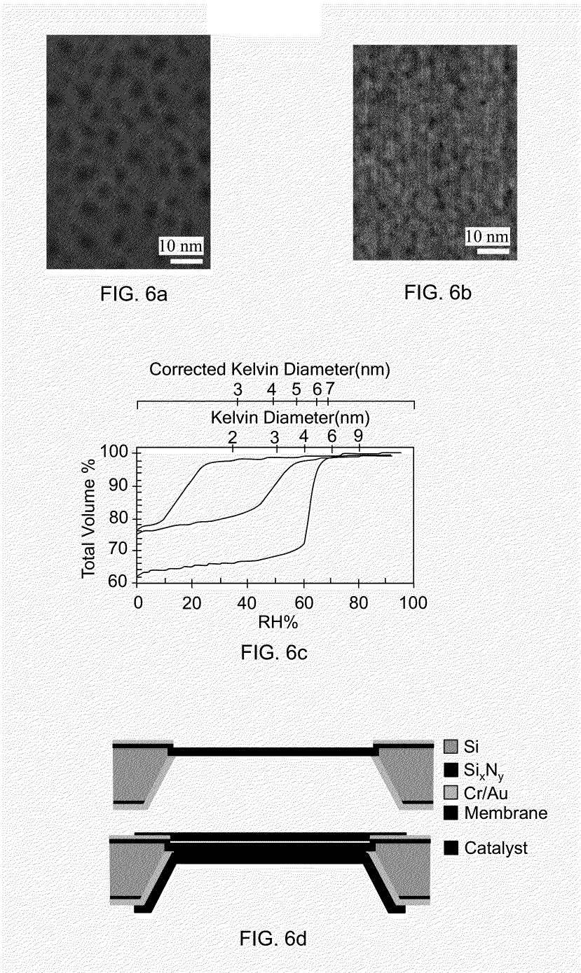

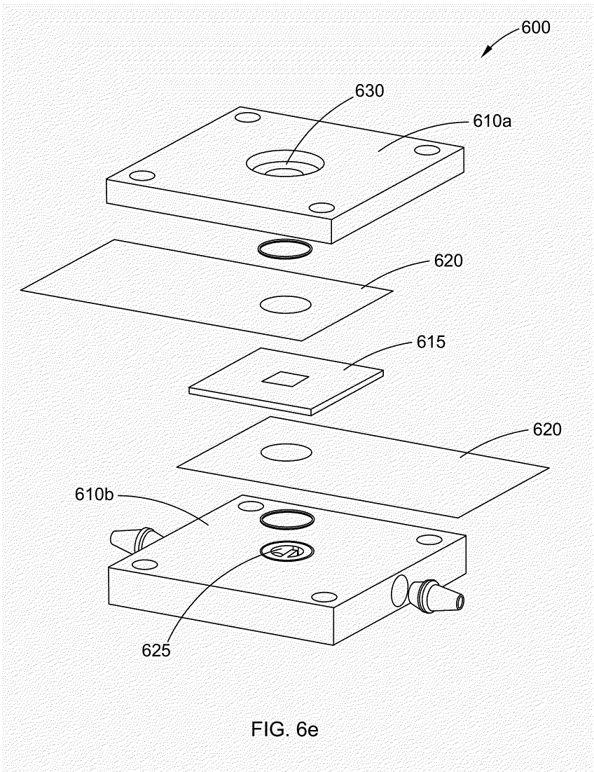

In order to create a thin hydrophilic silica aperture at the mouth of the pores, plasma-directed atomic layer deposition (PD-ALD) may be employed. Unlike conventional ALD, in PD-ALD, a remote plasma instead of water vapor exposure is used to activate the surface. Because both the plasma Debye length and the radical mean free path greatly exceed the pore diameter, surface activation and silica deposition are confined to the immediate external surface of the membrane pores with no deposition on internal pores. Successive oxygen plasma and tetramethyl orthosilicate (TMOS) exposures using an Ar carrier gas resulted in an approximately 2nm thick silica layer. The interiors of the pores within the silica layer were then functionalized with MPTMS. The maximum diameter of the pores at the two surfaces of the membrane is approximately 2 nm as estimated from SEM and analysis of water adsorption isotherms (FIG. 6).

### EXAMPLE 5

### Fabrication of Membrane Electrode Assembly (MEA)

The last fabrication stage of the MEA was spray painting the anode and cathode catalysts on the membrane (FIG. 6(d)). A catalyst ink with an 18 wt % ratio of Nafion ionomer 1100 EW (from Solution Technology, Inc.) to platinum black (from Alfa Aesar Co.) was prepared in de-ionized (DI) water and isopropyl alcohol (IPA). Direct spray painting of the catalyst ink on the membrane was straight forward since the membrane did not swell and wrinkle as the catalyst solution came in contact with the membrane surface. The membrane was set on a hot plate at 85° C. during spraying. As mentioned previously, and shown in FIG. 3(d), Cr/Au layers already deposited on both sides of the die are used as current collectors. The catalyst layer overlaps with the Cr/Au electrode around the edges of the membrane and provides electrical connectivity. The platinum loading in the catalyst layers was 7 mg/cm².

### EXAMPLE 6

### Characterization of MEA

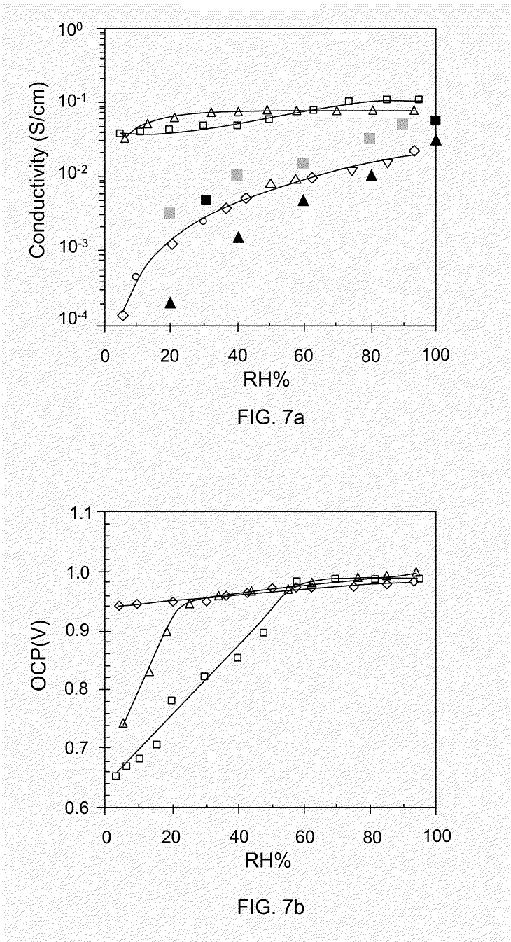

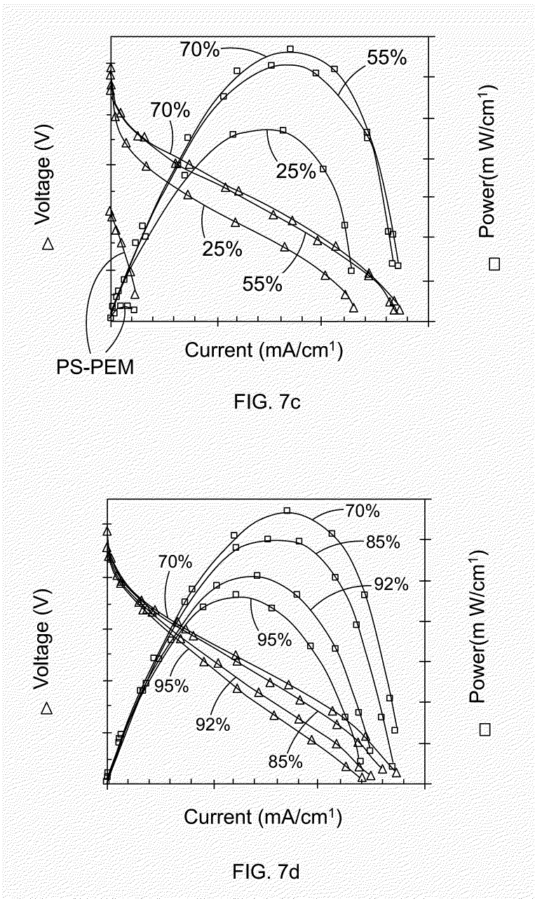

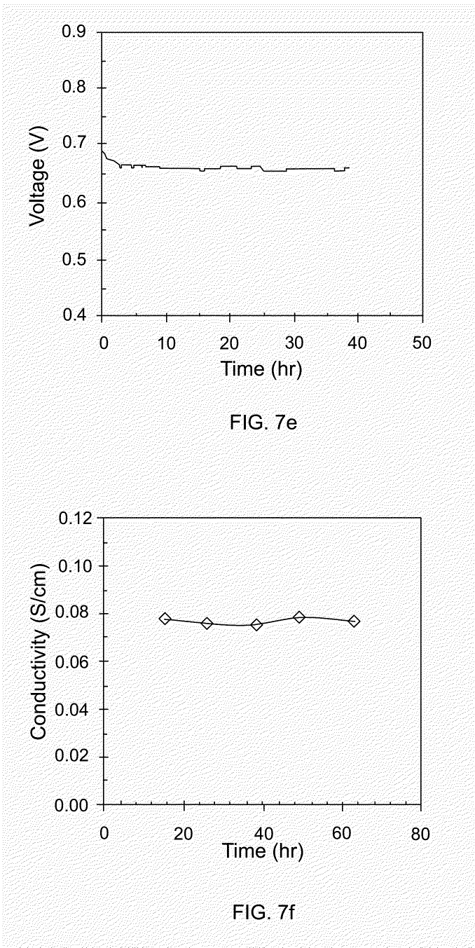

All tests were conducted on the MEA in a configuration most relevant to MFCs, where no auxiliary equipment for conditioning the membrane as well as the supply gases is desired, i.e. dry hydrogen is supplied to the anode and the cathode is air-breathing at room temperature (−25° C.). The test package (FIG. 6(e)) was left in an environmental chamber to simulate different ambient humidity levels (uncertainty in humidity measurement was ±2%). The membrane proton conductivity was measured using the four-probe technique (using Solartron 1287). The results (MEA-1) are compared (FIG. 7) with another silicon-based MEA but without the PD-ALD-deposited silica layers (MEA-2) as well as a MEA based on DuPont Nafion PFSA NRE-211 membrane (MEA-3) with a nominal thickness of 25 microns. This MEA has been fabricated through sandwiching Nafion between two stainless steel (SS) foils with 2×2 mm² square openings aligned during adhesive bonding of the layers together. The exposed 2×2 mm² Nafion membrane was subsequently brush painted with catalyst. Before discussing various differences between the developed membrane and Nafion, it should be mentioned that adding the silica layer has resulted in approximately 25% decline in the maximum conductivity of the PS-PEM, from about 0.11 S/cm to 0.08 S/cm. This significant decline is most likely due to the closure of some of the smaller membrane pores after the PD-ALD and the subsequent self-assembly processes rather than impeded proton mobility at the smaller entrance and exit of the pores, considering the small thickness of the silica layers.

Aside from this observation, the results show that conductivity of the MEA-1 membrane is almost constant down to approximately 20% humidity and then starts to significantly decline. A similar trend is seen in the case of MEA-2 membrane, but with a decline at a higher humidity level (50-60%). This difference is expected between the two membranes, since smaller pore diameter allows the water meniscus to remain stable at a lower humidity ambient. Decline in humidity levels beyond this thermodynamic equilibrium condition leads to the partial dryout of the pores, and an increase in crossover as evidenced by a drop in OCP (FIG. 7(b)). Overall, the data suggest a nearly humidity-independent conductivity as long as the vapor pressure at the membrane/ambient interface remains below the ambient saturated vapor pressure, so that the ambient vapor condenses within the pores keeping them filled with water. This fundamentally different attribute of the Si-based membrane over that of Nafion in which pores shrink at low ambient humidity, is a major factor responsible for the difference in conductivity of these two membranes. When the Nafion pores shrink, the amount of bulk-like water at the center of the pores sharply declines. Shrinkage along with reduction in interconnectivity of the water clusters is responsible for the exponential decay in Nafion conductivity.

Conductivity of the MEA-1 and MEA-2 membrane is 3.5 and 4.8 times, respectively, greater than that of the MEA-3 at 95% humidity. However, it should be noted that the MEA-3 has gone through a 100° C. hot-pressing step (as part of its fabrication process) widely known to adversely affect Nafion conductivity. Our data on MEA-3 at high humidity closely matches data on N-117 membrane heat-treated at 105° C. provided in a study by Sone et al. (J. Electrochem. Soc. 143 (1996) 1254-1259). At low humidity, however, conductivity of the MEA-3 membrane is an order of magnitude higher than that of the heat-treated N-117. Data on non-heat-treated N-117 membrane from Zawodzinski et al. (J. Electrochem. Soc. 140 (1993) 1981-1985) and Sumner et al. (J. Electrochem. Soc. 145 (1998) 107-110) are also provided in FIG. 7(a) for further comparison. The data suggest a conductivity of about 0.06 S/cm at 95% humidity for non-heat-treated Nafion that is moderately less than 0.08 S/cm and 0.11 S/cm conductivities associated with MEA-1 and MEA-2 membranes, respectively. Understanding the reasons behind higher conductivity of the PS-PEM compare to Nafion requires detailed characterization of the PS-PEM as well as a more concrete understanding of the Nafion structure and mechanisms of proton conductivity within its pores. Aside from morphological differences between the two membranes as well as the pores wall properties, difference in number density of the sulfonate groups on the pore wall and the length and chemistry of their pendant groups are among the parameters that can affect proton mobility.

Current-voltage (I-V) performance of the MEA-1 at different humidity levels is provided in FIGS. 7(c)-7(d). The MEA delivered a maximum power density of 332 mW/cm² at 70% humidity. However, operation at lower humidity led to a decline in performance primarily due to an increase in activation overpotential losses resulting from an increase in charge transfer resistance within the catalyst layer due to Nafion dryout. Although the greater loss and its effect on the maximum power density was minimal at 55% humidity, further reducing the humidity to 25% resulted in a significant activation loss that led to approximately 30% decline in maximum output power. Operation at high humidity levels also led to performance degradation (FIG. 7(d)) as a result of partial water flooding of the cathode catalyst due to a low water evaporation rate. In addition to I-V performance tests, an MEA was subjected to continuous operation at 150 mA/cm² for 40 hrs. Aside from a 0.018 V drop during the first 5 hrs of operation (FIG. 7(e)), believed to be mainly due to the system reaching steady state, the device showed an additional 0.007 V drop over the rest of the test duration (0.18 mV/hr). To determine if the changes in the membrane proton conductivity were responsible for the observed drop in potential, a second test was conducted in which the membrane conductivity was measured frequently after periods of operation (FIG. 7(f)). The results did not show any statistically significant change in membrane conductivity. Thus, the membrane conductivity does not seem to be responsible for the decline observed in the MEA performance.

The concept of a surface nano-engineered fixed-geometry proton exchange membrane that can enable nearly constant proton conductivity over a wide humidity range with no changes in volume and the fabrication of such a membrane based on silicon have been described. The technology may greatly facilitate manufacturing of membrane electrode assemblies (MEAS) and their further integration with microfabricated elements of MFCs. Due to the many advantages of this PEM/MEA, the inventors believe that this technology can simplify fabrication and operation of small fuel cells.

The fabrication processes developed to create the PS-PEM provide a versatile route to nanostructuring membranes with tailored properties for optimum performance. The ability to modify the surface of this dimensionally stable membrane opens up vast opportunities to fine tune the membrane's characteristics (e.g., water and fuel transport through the membrane) enabling development of better fuel cells. The technologies presented in this work can potentially be used for low crossover membranes for liquid fuels, membranes for above ambient operating temperatures (120-140° C.), anion exchange membranes, etc. In addition, the known geometry of the pores and the ability to systematically control the pore surface chemistry with SAMs provide a unique opportunity to enhance our understanding of the physics of proton transport and its relation to pore size and surface properties.

Although the present invention has been described with reference to certain embodiments thereof, other embodiments are possible without departing from the present invention. The spirit and scope of the appended claims should not be limited, therefore, to the description of the preferred embodiments contained herein. All embodiments that come within the meaning of the claims, either literally or by equivalence, are intended to be embraced therein. Furthermore, the advantages described above are not necessarily the only advantages of the invention, and it is not necessarily expected that all of the described advantages will be achieved with every embodiment of the invention.

1. A silicon-based proton exchange membrane for a membrane electrode assembly, the proton exchange membrane comprising:
a silicon wafer including a back side, a front side, and a membrane region therebetween,
the membrane region comprising a plurality of channels extending from openings in the front side of the silicon wafer through the membrane region to openings in the back side of the silicon wafer, the channels comprising active sites on walls thereof for attachment to molecular species,
each of the front side and the back side including a porous capping layer thereon, the porous capping layer comprising a plurality of through-thickness apertures contiguous with at least a portion of the channels of the membrane region.

2. The membrane of claim 1 wherein the membrane region has a thickness of between about 10 microns and about 40 microns.

3. The membrane of claim 1 wherein the porous capping layer comprises a thickness of about 5 nm or less.

4. The membrane of claim 1 wherein the channels comprise a diameter of between about 2 nm and about 10 nm and an average center-to-center spacing of between about 4 nm and about 20 nm.

5. The membrane of claim 1 wherein the channels comprise a length-to-width aspect ratio of from about 1,000 to about 20,000.

6. The membrane of claim 1 wherein the through-thickness apertures decrease in diameter in a direction away from the porous silicon membrane, thereby decreasing a size of the openings to the channels.

7. The membrane of claim 1 further comprising molecular species attached to active sites on the walls of the channels.

8. The membrane of claim 7 wherein a surface coverage of the molecular species on the walls of the channels is about 5 molecules per square nanometer.

9. The membrane of claim 1 further comprising molecular species attached to active sites on walls of the through-thickness apertures.

10. The membrane of claim 1 wherein the porous capping layer comprises silica.

11. A method of making a silicon-based proton exchange membrane for a membrane electrode assembly, the method comprising:
providing a silicon wafer comprising a thinned membrane region and having a back side and a front side, the silicon wafer further comprising a first metal layer on the back side and a second metal layer on the first metal layer, the first and second metal layers extending over the membrane region;
forming a plurality of channels in the front side of the silicon wafer;
extending one or more of the channels through the membrane region to the back side of the silicon wafer, forming one or more openings in the back side;
removing one or more portions of the first metal layer exposed by the one or more openings in the backside, thereby forming one or more exposed portions of the second metal layer;
delaminating the one or more exposed portions of the second metal layer from the first metal layer;
delaminating an entirety of the second metal layer after substantially all of the channels extend through the membrane region to the back side, thereby forming a porous silicon membrane comprising a plurality of through-thickness pores.

12. The method of claim 11 wherein forming the plurality of the channels in the front side of the silicon wafer comprises etching the silicon wafer, the etching comprising forming an anodization cell by immersing the silicon wafer and a cathode electrode in an electrolyte solution and running an electrical current through the anodization cell, and wherein delaminating portions of the second metal layer comprises terminating the etching of the silicon wafer proximate to the openings, the etching continuing in other regions of the silicon wafer.

13. The method of claim 11 wherein removing the one or more portions of the first metal layer comprises etching the first metal layer.

14. The method of claim 11 wherein the first metal layer comprises a transition metal selected from the group consisting of chromium, titanium and tungsten, and wherein the second metal layer comprises a noble metal.

15. The method of claim 11 further comprising, after forming the porous silicon membrane, attaching a molecular species to active sites on walls of the through-thickness pores.

16. The method of claim 15 wherein attaching the molecular species to the active sites comprises continuously flowing a precursor solution through the through-thickness pores.

17. The method of claim 16 wherein the precursor solution is a benzene solution comprising (3-mercaptopropyl)trimethoxysilane.

18. The method of claim 16 wherein the precursor solution comprises a solute concentration of between about 1 mM and about 10 mM.

19. The method of claim 15 further comprising, after attaching the molecular species to the active sites, oxidizing the molecular species.

20. The method of claim 11 further comprising forming a porous capping layer on each of the front side and the back side of the porous silicon membrane by depositing a thin film of about 5 nm or less in thickness on each of the front side and the back side of the porous silicon membrane, the thin film comprising a plurality of through-thickness apertures contiguous with at least a portion of the through-thickness pores of the porous silicon membrane.
